(19) United States
(12) Patent Application Publication
(10) Pub. No.: US 2004/0188876 A1
(43) Pub. Date: Sep. 30, 2004

(54) Coating of conductor lines

(76) Inventors: Thomas Baumann, Wettingen (CH); Albrecht Bock, Viernheim (DE); Bodo Bruehl, Waldshut-Tiengen (DE); Joerg Oesterheld, Birmenstorf (CH); Daniel Schulz, Oberrieden (CH)

Correspondence Address: CERMAK & KENEALY LLP, P.O. BOX 7518, ALEXANDRIA, VA, 22307, US

(21) Appl. No.: 10/760,304

(22) Filed: Jan. 21, 2004

(30) Foreign Application Priority Data
Jul. 22, 2002 (WO) PCT/IB02/02857
Jul. 21, 2001 (DE) 101 35 717.6

(51) Int. Cl. B29C 47/06

(52) U.S. Cl. 264/40.1; 425/113; 264/171.15

(57) ABSTRACT

The invention relates to devices (50, 100) and a method for the coating of conductor lines, in particular for the insulation of stator windings of rotating electrical machines. According to the invention, an extruder head (50) is provided for use in a device for the coating of a conductor or a conductor line (72), having at least one extruder die (56), which is connected on one side to a supply conduit (58) for feeding the coating material. On the other side, the extruder die (56) opens out into into a region to which the conductor that is to be coated or the conductor line that is to be coated is adjacent during operation. Furthermore, the outlet of the extruder die (56) can be closed by means of a seal (57).

### TECHNICAL FIELD

The invention relates to devices and a method for the coating of conductor lines, in particular for the insulation of stator windings of rotating electrical machines.

### PRIOR ART

In many areas of technology it is necessary for conductors or conductor lines which comprise one or more individual conductors or for other cables to be provided with a coating. The coating may serve the purpose here of electrical insulation, thermal shielding, mechanical support, combinations of these or else some other purpose, such as for example sealing from moisture or else simply for performing a packaging kind of function.

Stator windings of rotating electrical machines, such as generators for example, generally comprise a multiplicity of individual bars with usually a rectangular conductor cross section. These stator windings are usually coated with at least one insulation, also referred to as main insulation. During the operation of the rotating electrical machine, the insulation of a stator winding is subjected to combined loading. The sometimes very high voltage induced in the winding as a result of the magnetic field of the rotor has the effect that the insulation between the conductor and the slot wall is dielectrically loaded by a resulting electric field in a form corresponding to the thickness of the insulation. The laminated stator core surrounding the stator is in this case at ground potential.

The insulation is additionally subjected to alternating thermal loading due to the ohmic losses produced in the conductor. Acting together with different thermal expansions of the materials involved, this thermal loading also leads to alternating mechanical loading in the insulation and also at the interface between the conductor and the insulation, as well as at the interface between the insulation and the slot wall. This results on the one hand in shear loading of the adhesive bond of the insulation on the conductor and in a risk of abrasion. Apart from the operational loads, the insulation is also already subjected to high mechanical loads in particular even during production and fitting into the stator.

Various methods are known in the prior art for producing insulating coatings for stator windings that ensure an adequate insulating capability under all operating conditions in conjunction with a long service life. Usually, mica paper is used as the base material for insulations of stator windings, often being mechanically reinforced by an additional glass fabric support. For this purpose, the mica paper in strip form is wound around the stator conductor line and subsequently impregnated with a resin. After curing of the resin, a thermosetting insulation of the conductor line is thus produced. Also known in the prior art are insulations with a thermoplastic matrix, such as for example shellac, polysulfone and polyether ketone, which are plastically deformable again above the melting temperature of the matrix.

The complicated and time-intensive production steps, which lead to considerable production costs, are to be considered as disadvantages of this method known from the prior art for producing insulations for stator windings. To be mentioned in particular in this connection are the winding process and the impregnating process, which cannot be speeded up to any further significant extent because of the physical properties of the materials involved. In addition, defects often occur in the production process, in particular in the case of thick insulations. For example, inaccurate adjustment of the winding machine, for example adjustment at an incorrect angle in relation to the conductor line or a statically acting tensile force, or else a dynamically occurring reduction of the tensile force, can cause an inadequate insulating structure with folds or even tears in the mica paper. As a consequence of excessive strip being applied in the impregnating mold, instances of excessive pressing can occur, preventing uniform impregnation through the insulation or causing local defects with reduced short-term and/or long-term dielectric strength.

Further production methods for the coating of conductor lines and conductor bundles are known from cable technology. In the methods known from the prior art, conductor bundles with round cross sections are in this case coated in an extrusion process with a thermoplastic, preferably polyethylene, with to some extent subsequent crosslinking, or with an elastomer, preferably silicone elastomer or fluororubber. The methods of pressure coating and tube coating are used for this purpose. In pressure coating, the coating of a conductor line takes place under pressure, i.e. the initially flowable coating material is applied to the conductor line under pressure via suitable feed channels. FIG. 1 shows in a schematized way the construction of a device suitable for this purpose and the operation of pressure coating a conductor line. The clear width of the feed channels can be changed by means of a sleeve, which is preferably displaceable in the longitudinal direction. An advantage of this method is that the melt also penetrates into interstices that are present, something which can be supported by an additional vacuum, so that this method is very well suited for applying a semiconducting inner conductor-smoothing layer. The adhesive strength of the polymer on the substrate is also positively influenced by the pressure. In the tube coating method, similarly represented in a schematized way in FIG. 2, on the other hand, a molten tube is produced and then provided with an inner radius as it emerges at the end of the die. The inner radius is in this case greater than the outer radius of the conductor to be coated. The application of the tube to the conductor is achieved by the conductor being drawn off from the end of the die at a greater speed than the molten tube emerges from the die head. A vacuum between the tube and the conductor allows the application at the exit of the die head to be supported. It is also generally possible here to dispense with a subsequent calibration of the thickness of the coating, i.e. a preferably mechanized control of the thickness with simultaneous smoothing of unevennesses. Directly after emerging from the die head, the coated conductor goes into a cooling zone, in which the coating cures. In the case of the pressure coating described above, such a calibration advantageously takes place by means of a die exit cross section.

However, the methods described above are not suitable, or suitable only to a restricted extent, for the coating of conductor lines of any desired cross section, such as for example a rectangular cross section, and/or complicated conductor line contours, such as for example kinked or bent shapes.

In U.S. Pat. No. 5,650,031 there is a description of a device and a method for this purpose, with which a conductor line of any desired cross section and complicated conductor line contour can be coated with a thermoplastic. For this purpose, a die with a tapering through-opening is used, the conductor line being guided through the through-opening. The greater opening at the entry into the die together with an only small contact surface area at the exit from the die ensures a certain angular mobility of the conductor line guided in the through-opening. As an alternative here, either the conductor line can be advanced with the die fixed or the die displaced along the fixed conductor line.

A major disadvantage of the method known from U.S. Pat. No. 5,650,031 and also of the further methods described above for the coating of conductor lines is the continuous operating mode required to achieve a uniform molten film of the coating material and consequently a uniform coating thickness. The part of the conductor line that is coated during the starting-up process must generally be cut off as scrap on account of the unacceptable irregularities of the coating. In the case of any desired cross section of the conductor line, for example a rectangular profile, particularly serious irregularities of the coating, in particular of the thickness of the coating, form during the starting-up process.

### SUMMARY OF THE INVENTION

The invention is therefore based on the object of providing a device and a method by means of which it is possible to cover conductor lines with any desired cross sections and any desired contour profiles with a coating material, preferably a thermoplastic or an elastomer, expediently while avoiding the disadvantages known from the prior art, or to coat said conductor lines completely with this coating material. The coating is to be of a high quality, i.e. have both good adhesiveness on the conductor line and a largely uniform thickness. In comparison with the prior art, the operation of covering/coating in particular a multiplicity of conductor lines that are fed to the coating device is to be performed in a simplified manner. It is intended in particular to be possible here to provide a multiplicity of individual conductor lines with a high-quality coating in the case of continuous feeding and also discontinuous feeding.

This object is achieved according to the invention by an extruder head, an extrusion device and a method for the coating of a conductor line according to the patent claims.

In the text which follows, usually only the operation of coating a conductor or a conductor line is described. However, the invention equally relates to devices and methods for the coating of a conductor or a conductor line in only a portion of the conductor or the conductor line. A portion refers here both to a portion in the axial direction and to a portion in the peripheral direction.

The extruder head according to the invention for use in a device for the coating of a conductor line usually has an extruder die which is connected or can be connected on the inlet side to a supply conduit or feed of the coating material and opens out on the outlet side into a region to which the conductor line that is to be coated is adjacent during operation. Furthermore, the outlet of the extruder die can be closed by means of a seal. Consequently, it is possible to convey coating material continuously, but to open the extruder die only when required, so that coating material emerges from the extruder die only when the extruder die is open. As soon as the conductor line is covered or coated with coating material in the region that is to be coated, the extruder die is closed again, so that no further coating material emerges from the extruder die. With further continuous conveyance of the coating material, which may take place for example with the aid of a conveying screw, the conveying pressure of the coating material continues to be maintained in the region upstream of the seal. The conveying screw is for this purpose expediently connected to the extruder die by means of the feed conduit. If the seal is opened again, a volumetric flow of the coating material that is constant over time emerges once again from the extruder die after a very short starting-up phase. The starting-up phase until a constant volumetric flow is built up is consequently shortened considerably in comparison with the prior art, so that a uniform thickness of the coating of the conductor line is achieved already after a very short starting-up time. Consequently, scrap no longer occurs, or occurs only at least to a distinctly reduced extent in comparison with methods and devices known from the prior art.

A bypass branch is advantageously arranged upstream of the seal in the feeding direction of the coating material. In the case in which the extruder die is closed, the continuously conveyed coating material can flow away via this bypass branch without an excessive build-up occurring upstream of the extruder die. This is advantageous in particular for the reasons since on the one hand the pressure of the coating material in the feed conduit is kept at a constant level even when the extruder die is closed and on the other hand possible curing of the coating material upstream of the closed extruder die is also prevented. On account of the constant pressure level, an excessive, though brief, outflow of coating material does not occur even in the case in which the seal of the extruder die is opened. Rather, directly after the opening of the seal there is already a constant volumetric flow, which also continues to remain unchanged, so that the formation of a coating thickness of the conductor line that is uniform from the outset is possible. Furthermore, the bypass branch prevents coating material from curing by remaining too long directly upstream of the seal. In the case of thermoplastics, such curing could occur for example due to cooling on account of the heat exchange with the extruder die and/or the supply conduit. In the case of an elastomer as the coating material, a crosslinking reaction could already commence in the supply conduit and thus lead to at least partial curing. As a result, the feed could be at least reduced or even entirely blocked in its cross section, which in any event would subsequently cause an uneven inflow and, as a result, ultimately an uneven coating thickness. However, the bypass branch prevents coating material from accumulating upstream of the seal even after the latter has been closed, and from curing there. The bypass branch is advantageously connected via a conduit to a collecting container, into which the branched coating material is discharged and from which it can also be passed on to a recycling process. As an alternative, curing in the event of the use of thermoplastics can also be prevented by suitable heating.

The region into which the extruder die opens out is advantageously configured as a void arranged in the extruder head, with a cross section corresponding to the conductor line and allowing for the form-dependent extrusion shrinkage. During the operation of the extruder head, the conductor line moves in relation to the extruder die along the void. Between the void and the conductor line there remains an intermediate space, into which the coating material is introduced. For guiding the conductor line in the void, guiding pins or other guiding elements which bridge the intermediate space may additionally be arranged in the void. Since a shrinkage occurs during the curing of most suitable coating materials, the intermediate space is expediently made to be larger than the coating thickness to be achieved, at least by the form-dependent extrusion shrinkage of the coating material. Furthermore, the extruder die preferably opens out essentially radially into the void. This ensures that the coating material which emerges from the extruder die and impinges essentially frontally onto the conductor line is distributed over the entire free space. The overall axial length of the extruder head can be minimized as a result.

The extruder head formed in such a way makes it possible to process conductor lines of a wide variety of cross sections, such as for example with round and oval or elliptical cross sections, but in particular also with rectangular or polygonal cross sections.

In a particularly preferred embodiment, the cross section of the region into which the extruder die opens out tapers in the axial direction of the conductor line from the conductor line entry cross section to the conductor line exit cross section in a way corresponding to the extrusion shrinkage occurring in this region. This makes it possible to ensure that the coating of the conductor line in the region of the extruder head undergoes a uniformly forming compressive force everywhere in the region of the extruder head in spite of extrusion shrinkage. This supports the uniform formation of the coating.

Particularly expediently, the length of the extruder head in the axial direction of the conductor line is less than one tenth, preferably less than one twentieth, of a radius of the conductor line contour. If the conductor line contour has a number of radii, the smallest radius is expediently to be taken into account here as a reference radius. This makes it possible that the conductor line can also be guided along the void in bent or kinked regions and coated with the aid of the extruder head, with no or only minimal irregularities of the coating thickness occurring in the bent or kinked regions of the conductor line. Together with a void expediently tapering from the entry cross section to the exit cross section, with the region upstream of the extruder die expediently having a greater tapering angle than the angle corresponding to the degree of shrinkage, positive engagement of the conductor line together with the coating against the bounding walls of the void only occurs along a partial region of the void. The shorter this partial region is, with at the same time an adequately large tapering angle, the more tolerant the extruder head is with regard to incorrect angles in the alignment of the conductor line in relation to the center axis of the void. Bent or kinked conductor line portions automatically lead to an incorrect angle in the alignment.

At the periphery of the void, a multiplicity of extruder dies are expediently arranged in such a distributed manner that a uniform layer thickness of the coating material forms on the periphery of the conductor line. For this purpose, the extruder dies are to be arranged at shortened intervals in relation to one another, in particular in regions of corners of the void.

In some cases, it is also advantageous to additionally compress the coating material. For this purpose, the region into which the extruder dies open out expediently tapers in the axial direction of the conductor line from the conductor line entry cross section to the conductor line exit cross section to a greater extent than would be necessary for the adaptation to the extrusion shrinkage alone. As an alternative or else in addition, restrictor bars and/or restrictor-ring segments, which are preferably adjustable, may also be arranged in this region for the aforementioned purpose.

The extruder head may be designed on the principle of pressure coating or else on the principle of tube coating. Further configurational features of the extruder head, such as for example the presence of an adjustable or else fixed sleeve, pressurization of the fed coating material or else application of a vacuum as well as further features can accordingly also be implemented on the basis of the prior art.

It is also advantageously possible to arrange in each case two or more extruder dies one behind the other in the axial direction in the extruder head. By means of at least two dies arranged one behind the other, a corresponding number of different coating layers can also be applied on the conductor line in one procedure. The material may in this case vary from layer to layer. However, one and the same material may also be used for each layer. Such an extrusion of a number of layers is also suitable for achieving different conductivities in the individual layers while using only one base material, for example a polymer.

Elastomers or thermoplastics, both preferably mixed with a filler, or else B-stage thermosetting resins are expediently used as coating materials. Ethylene-propylene-diene monomer (EPDM) is preferably used as a suitable elastomer. In the case of machines that are subjected to high temperatures, a silicone elastomer is preferably used. Elastomers have the advantage of the relatively low requirements with respect to process temperature and process pressure during processing. Silicone elastomers also inherently have already a not insignificant resistance to partial electrical discharges and, in addition, age only to a small degree in an electric field. Examples of suitable thermoplastics that come into consideration are polyethylene, polypropylene, PET, and, for machines that are subjected to high temperatures, in particular high-temperature thermoplastics such as for example polyethylene naphthalate (PEN), polyether imide (PEI), polyphenylene sulfide (PPS), polyether sulfone (PES), polysulfone (PSU), polyether ketone (PEK) and polyetherether ketone (PEEK).

The material properties may be additionally set, expediently by adding active and passive fillers, such as for example powders or fibers, in such a way that the material meets the required mechanical and thermal requirements. In a particularly preferred embodiment of the invention, the fillers are additionally aligned in a preferential direction, in particular when fibers or platelets are used as the filler. The use of fillers generally has the effect of influencing the mechanical and thermal properties of a base material. For example, the thermal expansion of thermoplastics can be made to approximate that of a copper conductor by the addition of fillers. Thermoplastics usually have much higher coefficients of thermal expansion than copper conductors, leading to high mechanical stresses in the case of thermal expansion. Similarly, fillers can also be used for changing the viscosity of a thermoplastic. The alignment of the fillers in a preferred direction in the coating, in particular when fillers in the form of fibers or platelets are used, can advantageously lead on the one hand to a change, generally an increase, in the mechanical strength, but on the other hand also to a reduction in the thermal expansion in the longitudinal direction of the conductor as well as to an electrical barrier effect in the direction of the field.

In a further aspect of the invention, an extrusion device which has at least one extruder head according to the invention, as described above, and additionally a conveying element for conveying the coating material, is provided for the coating of a conductor line. Preferably used as the conveying element is a screw, which expediently sucks in coating material from a reservoir on the input side and expediently conveys it into a conduit connected to the extruder head on the output side. From there, the coating material passes to the at least one extruder die, which can be closed by means of a seal, and, when the seal is open, ultimately emerges from the extruder die in the way described above. In order to be able to perform the opening and closing of the seal of the extruder die in a positionally synchronized manner in dependence on the relative position of the conductor line that is to be coated, the extrusion device advantageously also comprises an automatic control system. This automatic control system comprises not only signal processing elements and signal conducting elements but also position sensors for detecting the position of the conductor line. As soon as the conductor line enters the region of the extruder die, the seal of the extruder die is opened and coating material passes through the extruder die onto the conductor line. Once the end of the conductor line is reached, the automatic control system detects this and in turn controls the closing of the seal of the extruder die by means of a control signal. Consequently, the operation of coating a conductor line as well as a multiplicity of conductor lines arranged one behind the other can proceed fully automatically, without control signals having to be generated manually. At the same time, it is ensured in this way that coating material only emerges from the extruder die when a region of a conductor line that is to be covered or coated is positioned in front of the extruder die.

The extrusion device also expediently comprises a transporting device, which transports the conductor line through the region into which the at least one extruder die opens out. This device preferably comprises clamping elements and roller elements, at least some of the latter being driven.

As an alternative to this, however, the extrusion device may also comprise a holding device for the conductor line and a transporting device for the extruder head, so that the extruder head can be guided along the stationary conductor line. Depending on whether the further elements of the extrusion device are connected to the extruder head in a fixed manner or by means of a flexible conduit, parts of the extrusion device must possibly also be moved here together with the extruder head.

In both cases, the drive and the guide expediently have multiaxial mobility, to be able to follow three-dimensionally formed conductor lines. It is also advantageous here if the movement is controlled by means of a preferably programmable controller or by means of a closed control loop.

In a preferred embodiment of the extrusion device, the latter also has a device for aligning filler in the form of fibers or platelets that is admixed with the base material. This is essentially a device for producing shearing forces in the direction of the intended alignment. This may be achieved by means of local constrictions in the flow of the coating material before or after the application to the conductor line. Shearing plates arranged in this region also fulfil this purpose.

Furthermore, one or more heating elements for heating the conductor line to a pre-heating temperature may be advantageously arranged. The heating elements may be, for example, an inductive heater, an infrared heater or else a hot-air heater. This is intended to prevent the coating material that impinges on the surface of the conductor line from cooling too quickly locally and curing prematurely as a result, whereby inadequate adhesion between the surface of the conductor line and the coating material could also occur. Here, it is also possible to pretreat the conductor line advantageously with an adhesion promoter. The pre-heating temperature, the die temperature (i.e. the temperature of the extruder head and/or the extruder die) and the temperature of the coating material are preferably to be sensed by sensors and controlled by means of a heating control.

In a preferred embodiment of the extrusion device, at least two extruder heads are arranged one behind the other axially, i.e. in the longitudinal direction of the conductor. By means of these at least two extruder heads arranged one behind the other, each extruder head having at least one extruder die, a number of layers of the coating can consequently be correspondingly applied on the conductor line in one procedure.

Expediently, the extrusion device additionally has a calibrating device, preferably at least one calibrating roller, arranged at the exit of the extruder head. This allows the thickness of the applied coating to be checked and any irregularities in the thickness distribution of the coating to be evened out. The calibrating roller advantageously acts here as a contact pressure roller, which exerts a contact pressing force on the coated conductor line. For this purpose, the calibrating roller is arranged at such a distance from the exit of the extruder head that the coating material is not yet completely cured.

A further aspect of the invention relates to a method for the coating of a conductor line. The method according to the invention here comprises the steps of:

a) continuously conveying a flowable coating material from a storing reservoir into a collecting reservoir;

b) producing a relative movement between the conductor line and an extruder head of an extrusion device;

c) guiding the conductor line along the extruder head, an intermediate space remaining between the conductor line and the extruder head;

d) introducing at least part of the continuously conveyed coating material into the intermediate space;

e) ending the introduction of coating material into the intermediate space as soon as the end of the region of the conductor line that is to be coated is reached.

A calibration of the thickness of the coating material may also advantageously take place in method step d.

Here, the coating material processed in the method according to the invention may be an elastomer or thermoplastic mixed with a filler in the form of fibers or platelets. The filler may additionally be advantageously aligned in the direction of extrusion in method step d.

### BRIEF DESCRIPTION OF THE DRAWINGS

Exemplary embodiments of the invention are represented in the drawings, in which:

FIG. 1 shows in a schematized representation a device for the pressure coating of a conductor known from the prior art;

FIG. 2 shows in a schematized representation a device for the tube coating of a conductor known from the prior art;

FIG. 3 shows in a sectional representation an extrusion device according to the invention with an extruder head according to the invention;

FIG. 4 shows a section through an extruder head with a rectangular void for the coating of rectangular conductor lines;

FIG. 5 shows a longitudinal section through a bent conductor line and an extruder head according to the invention;

FIG. 6 shows in a sectioned representation a further embodiment of an extruder head according to the invention which operates on the principle of pressure coating;

FIG. 7a shows in a sectioned representation a further embodiment of an extruder head according to the invention which operates on the principle of tube coating;

FIG. 7b shows a representation of a detail of the extruder head from FIG. 7a;

FIG. 8 shows a device for aligning a filler admixed with the coating base material;

FIG. 9 shows a number of conductor bars running through an extrusion device;

FIG. 10 shows a further extruder head according to the invention with in each case two extruder dies arranged one behind the other and a calibrating device arranged at the exit of the extruder head.

Components which are the same or act in the same way are largely provided with the same designations in the description which follows.

### WAYS OF IMPLEMENTING THE INVENTION

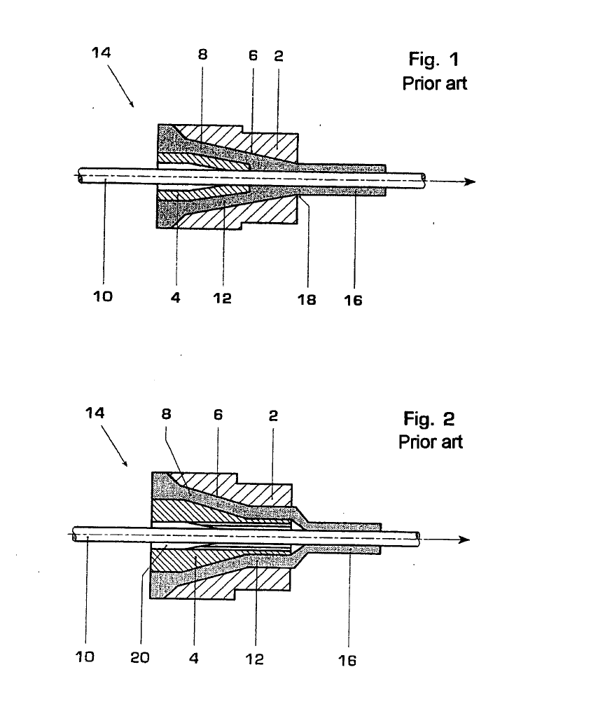

FIGS. 1 and 2 show devices known from the prior art for the coating of conductors or cables with round cross sections. The device represented in FIG. 1 operates here on the principle of pressure coating, the device represented in FIG. 2 on the principle of tube coating. Both devices essentially comprise an outer extruder head casing 2, which centrally has a tapering bore hole 6, and a sleeve 4 arranged in this bore hole. Between the outer extruder head casing 2 and the sleeve 4 there remains a conical intermediate space 8, through which the coating material can be fed. The sleeve 4 may be adjustable here in the axial direction, so that the clear width of the intermediate space 8 can be changed by means of an axial adjustment of the sleeve 4. The sleeve 4 is itself in turn similarly made hollow, so that during operation the conductor 10 that is to be coated or the cable 10 that is to be coated can be guided centrally through the entire arrangement. In order that the initially flowable coating material 12 can flow from a reservoir (not represented in FIG. 1) into a connecting conduit (similarly not represented) and ultimately through the intermediate space 8 between the extruder head casing 2 and the sleeve 4 onto the conductor 10, the coating material 12 is subjected to pressure either in the reservoir or by means of a conveying unit integrated in the supply conduit. This leads to the coating material 12 flowing out through the intermediate space 8 onto the conductor 10 that is to be coated and coating the latter in the way represented. Referably after emerging from the extruder head 14, the coating material cures, i.e. loses its flowability. The thickness of the coating 16 in the configuration represented in FIG. 1 is determined by the exit cross section 18 from the extruder head 14. A smaller thickness of the coating could be achieved here only by reducing the exit cross section 18. One advantage of pressure coating is that the liquid coating material also penetrates in particular into interstices that are present. This penetration of coating material into interstices that are present may also be supported by the application of a vacuum in the region of the feeding of the conductor.

The device represented in FIG. 2 on the other hand operates on the principle of tube coating. Here, a tube 12 of at least partly cured coating material is formed between the extruder head casing 2 and the sleeve 4 and emerges at the end of the extruder head 14 from the extruder head with a diameter that is greater in comparison with the diameter of the conductor 10 that is to be coated. The application of the tube 12 to the conductor 10 is achieved by the conductor 10 emerging from the extruder head 14 at a greater speed than the tube 12, so that a stretching of the tube 12 occurs here. The application of the tube 12 to the conductor 10 can in this case be supported by a vacuum which is applied in the rear region 20.

Both methods known from the prior art have the disadvantages described above. In particular, both methods can only be used in the way represented for the coating of round or slightly oval conductors which have a straight contour profile, i.e. without bending radii and/or kinks. Furthermore, both methods must be started up over a certain starting-up time until a steady state of the coating process is obtained. Within this starting-up time, considerable fluctuations in the quality of the coating of the conductor occur in the form of irregularities, in particular of the thickness of the coating, so that the part of the conductor that is coated in this starting-up time must be discarded as scrap.

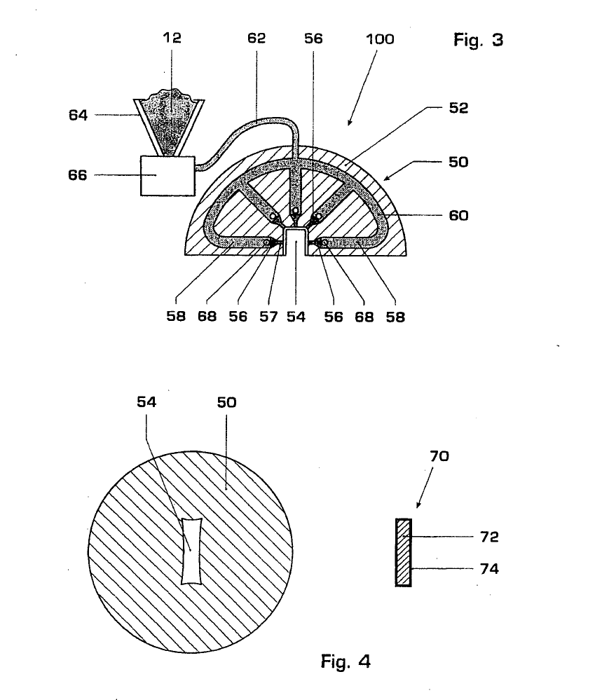

The disadvantages known from the prior art can be avoided by means of the extruder head 50 of an extrusion device 100 that is configured according to the invention and represented in FIG. 3. The extruder head 50 is represented in FIG. 3 in a section and here comprises firstly a semicircular basic body 52. Arranged in the basic body 52 there is a void 54, which is rectangular here and at the periphery of which five extruder dies 56 are arranged in a distributed manner in the embodiment of the invention represented here. The extruder dies 56 can be closed here in each case by means of a quickly closing seal 57. For this purpose, the seal 57 is advantageously arranged in each case as close as possible to where the extruder die 56 opens out into the void 54. Quick-acting hinged seals or sliding seals or else other kinds of seals are suitable here for example as the quickly closing seal. The extruder dies 56 are in each case connected on the side facing away from the void 54 to feed conduits 58, which in turn are connected to a common feed conduit 60 arranged in a semicircular manner in the basic body 52. The feed conduit 60 is in turn connected by means of a flexible conduit 62 to a reservoir 64. Arranged at the outflow from the reservoir 64 is a screw conveying element 66, which is schematically represented in FIG. 3 and ensures that coating material 12 is continuously conveyed from the reservoir 64 into the flexible conduit 62. The flowable coating material 12 conveyed from the reservoir 64 flows via the flexible conduit 62 into the annular conduit 60 and from there via the radially arranged, individual feed conduits 54 into the extruder dies 56. If the respective extruder die 56 is open, the coating material 12 flows into the void 54. Arranged upstream of the respective seal in the direction of flow, bypass channels 68 respectively branch off from the feed conduits 58 or the extruder dies 56 in the embodiment represented here. If the extruder die 56 concerned is closed, the conveyed coating material 12 can flow away via these bypass channels 68. The bypass channels 68 advantageously open out either directly into the reservoir 64 again or into a collecting container (not represented), from where the unused coating material 12 can be recycled.

On account of the void 54 of a rectangular configuration, the embodiment of the invention represented here makes it possible for a uniform coating thickness to be applied on the periphery of a conductor or a conductor line with a rectangular cross section. For this purpose, the cross section of the void 54 is made greater than the cross section of the conductor or the conductor line or the conductor portion or the conductor line portion that is to be coated, so that the conductor or the conductor line can be at least partly accommodated in the void 54. The free space remaining between the conductor or the conductor line can then be filled with coating material, which is fed via the extruder dies 56. The conductor or the conductor line expediently moves in this case with uniform speed perpendicularly to the plane of the representation, transporting with it in each case the coating material introduced into the free space. The coating material thereby cures in a way corresponding to the material.

In order to fill the rectangular free space with coating material uniformly everywhere, in the arrangement represented here extruder dies 56 are respectively arranged in the two corners of the void 54. The other extruder dies 56 are arranged in an evenly distributed manner approximately at the periphery of the void 54, so that a local accumulation of fed coating material and elsewhere a possible inadequate supply does not occur.

The embodiment of the extruder head represented here may be used moreover particularly advantageously in an arrangement of two extruder heads configured in this way, joined together to form a full circle, so that the two put-together voids 54 also accordingly form a closed rectangle. A conductor or a conductor line guided therein can consequently be coated over its entire periphery in one procedure.

In principle, it is possible both that the extruder head is guided along the contour of the conductor or the conductor line, or else that the conductor or the conductor line is transported through the void with the extruder head stationary. In both cases, in addition to the elements represented in FIG. 3, in particular further holding elements and driving elements are required, but these are sufficiently well known in the prior art.

FIG. 4 shows an advantageous embodiment of an extruder head 50 according to the invention. The void 54 is configured here with a closed, rectangular contour. However, the side walls of the void 54 do not run exactly straight, but have a concave shape. This concave shape of the side walls serves the purpose of allowing for the extrusion shrinkage occurring when the coating material cures. After curing of the coating material, consequently a coating layer that is uniformly thick overall is obtained on the periphery of the conductor or the conductor line. Represented in the right-hand part of FIG. 4 is the intended target profile 70, i.e. in cross section a rectangular conductor 72 with a coating 74 applied by means of an extrusion head 50. The concavity of the side faces of the void 54 is obtained in dependence on the extrusion shrinkage typical of the material, and consequently in dependence on the coating material used, on account of the geometrically determined accumulation of coating material in the corners, so that a greater extrusion shrinkage occurs there.

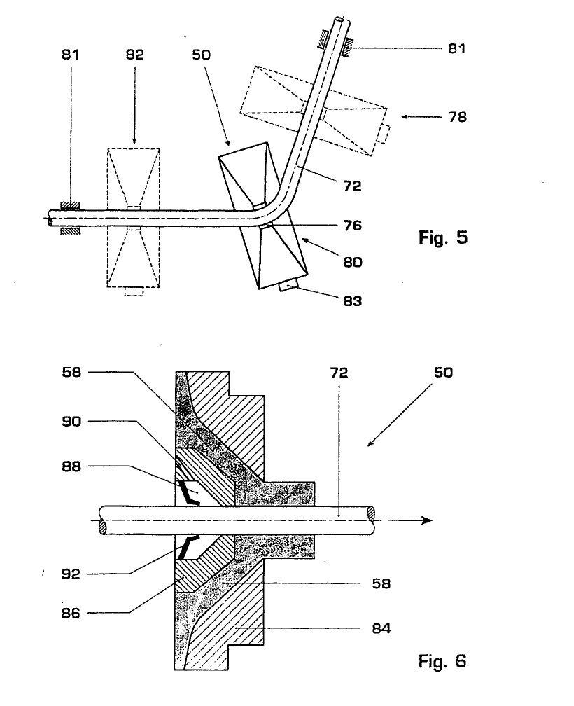

In order to allow conductors and conductor lines with a bent or kinked contour shape also to be coated, the extruder head is to be made as small as possible in the region in which it comes into contact with the conductor or the conductor line, in its overall thickness in the longitudinal direction of the conductor or the conductor line. Such an extruder head 50 according to the invention is represented in FIG. 5. The contact surface 76 between the extruder head 50 and the conductor 72 here is about one tenth of the represented radius of the conductor 72. It can be seen that the extruder head 50 can be moved along the conductor 72 from a first position 78, represented by dashed lines, via a second position 80, represented by solid lines, into a third position 82, in turn represented by dashed lines, and consequently can also follow the bent contour of the conductor 72. In spite of the bent contour, a uniform layer thickness of the coating is achieved here everywhere along the conductor. For this purpose, a holding device 81 is arranged on the conductor 72, and a transporting device 83 is arranged on the extruder head 50, so that the extruder head 56 can be guided along the stationary conductor 72.

The contact surface of the extruder head advantageously additionally has in relation to the conductor or the conductor line a cross-sectional constriction from the entry cross section to the exit cross section, in order in this way to exert an additional pressure on the coating layer forming. As a result of this, a shrinkage caused by cooling due to the contact of the coating material with the conductor is evened out, in particular.

The extruder head according to the invention may in principle also be operated on the basis of all known operating principles, that is, in particular, both on the basis of the pressure coating method already described above and on the basis of the tube coating method likewise already described above.

An exemplary embodiment of the extruder head 50 according to the invention which operates on the pressure coating principle is represented in FIG. 6. The extruder head 50 comprises an extruder head casing 84, which is provided with an inner bore hole, and a sleeve 86, which is arranged in the inner bore hole and is either fixedly adjusted, and consequently not axially adjustable, or else axially adjustable. The conductor line 72 and the bore-hole cross section of the sleeve 86 as well as the exit cross section of the extruder head casing 84 have a rectangular cross section here, as represented in FIGS. 3 and 4. In order to prevent a backflow of the coating material along the bore hole of the sleeve 86, the front bore-hole region 88 of the sleeve 86 is also subjected to positive pressure. The front bore-hole region 88 of the sleeve 86 is in this case connected via one or more feeds 90 to a positive-pressure reservoir and sealed with respect to the surroundings by means of a sealing lip 92. A backflow of coating material into the front bore-hole region 88 of the sleeve 86 could occur for example in the case of excessive gaps between the bore hole and the conductor line.

In order to allow a small overall axial length of the extruder head 50 to be realized, the feed channels 58 between the extruder head casing 84 and the sleeve 86 run essentially radially, i.e. the angle between the longitudinal axis of the conductor line and the feed channel is preferably more than 45° and less than 90°, particularly preferably more than 70°. The feed channels 58 may be configured with any desired cross section. The feed channels 58 are preferably configured with a round or elliptical cross section.

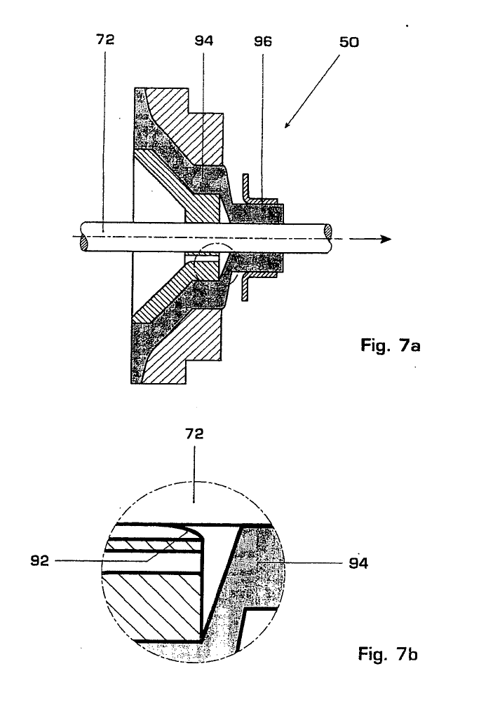

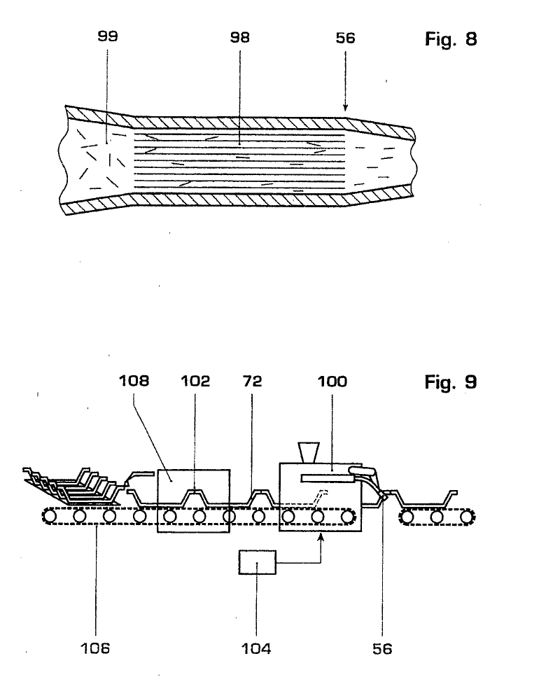

The further embodiment of the extruder head 50 according to the invention that is represented in FIG. 7a operates on the principle of tube coating. The conductor line 72 is advanced more quickly than the coating sleeve 94 is fed to the conductor line 72, whereby a stretching of the tube 94 occurs. On account of the stretching, a dimensionally exact application of the coating sleeve 94 to the conductor line 72 in turn occurs. A dimensionally exact application may also be obtained moreover by utilizing the extrusion shrinkage of the tube material, i.e. the shrinking process as a result of cooling. The coating tube 94 consists of coating material which has already cured at least to the extent that it does not tear as a result of the tensile force acting. On the other hand, however, the material must not have cured to the extent that it can no longer be deformed.

The application of the tube 94 may also be supported by a vacuum which is applied via one or more feeds between the tube 94 and the conductor line 72. In the case of the expedient application of a vacuum, the region between the tube 94 and the conductor line 72 is to be sealed off by means of suitable sealing lips 92, as represented for example in FIG. 7b. The exit cross section of the embodiment represented in FIG. 7a is in turn rectangular. In order to achieve a very high uniformity of the outer contour, there is additionally arranged here downstream of the extruder head a calibrating and contact pressure device 96 in the form of a corresponding profile, which exerts a forming force on the coating and in this way eliminates irregularities in the not yet completely cured coating. Materials suitable for processing with the extruder head according to the invention and the extrusion device according to the invention that come into consideration for the coating are preferably thermoplastics, particularly preferably elastomers. Examples of thermoplastics that come into consideration here are polyethylene (PE), polypropylene (PP), polyethylene terephthalate (PET) or else high-temperature thermoplastics, such as for example PEN, PEI, polyphenylene sulfide (PPS), PES, PSU, polyether ketone (PEK) and PEEK. Examples of elastomers that come into consideration are EPDM and, for machines that are subjected to high temperatures, preferably silicone elastomers.

In order in addition to influence the material properties positively in a desired way, for example in order to increase the strength of the material or to adapt the coefficient of thermal expansion of the coating material to the coefficient of thermal expansion of the conductor or the conductor line, powdered or fibrous, both active and passive fillers can be admixed with the thermoplastics and also the elastomers. In particular when fillers in the form of fibers or platelets are used, the fibers or platelets are initially randomly distributed without having a preferred alignment. In some cases it is desirable to align the fibers or platelets in a preferred direction, in order to achieve or optimize a specific effect in this way. For example, by alignment of the fibers or platelets in the longitudinal direction of the conductor, the coefficient of expansion of the coating material in this direction can be reduced to the maximum extent. Moreover, an electrical barrier effect in the direction of the field is produced in this way.

A device for the alignment of a filler admixed with the coating base material is represented in FIG. 8. Arranged for this purpose upstream of or in the extruder die 56 are shearing channels 98, which lead to shearing forces in the extrusion material, i.e. the mixture of coating base material and the filling material. The shearing channels 98 thereby subdivide either the supply conduit channel upstream of the extruder die or the extruder die into thin individual layers, so that when the extrusion material flows through these shearing channels an alignment of the filler in the form of fibers or platelets occurs in the direction of the shearing channels. In the case of thin supply conduit channels or extruder dies, it is often not necessary for shearing channels to be additionally installed, since the wall friction occurring here leads to adequate alignment of the filler.

FIG. 9 shows an extrusion device 100 for conductors or conductor lines with a bent or kinked contour shape, which is capable by corresponding design of also coating three-dimensionally bent conductor bars with a coating material. For this purpose, a number of conductors 72 are connected to one another by means of provisional connections 102, for example by soldering, welding, adhesive bonding etc., to form a virtually endless conductor 72, and are continuously coated in this form by the extruder die 56. The extrusion device 100 has an automatic control system 104, which controls an opening or closing of the seal of the extruder die 56 in dependence on the relative position of the conductor 72 that is to be coated in relation to the extruder die 56. Furthermore, the extrusion device 100 comprises a transporting device 106, which transports the conductors 72 through the region into which the extruder die 56 opens out. Finally, the extrusion device 100 has a heating element 108, which heats the conductors 72 to a pre-heating temperature. It is also possible of course for a number of heating elements to be arranged. Not represented is the concluding separation of the provisional connection of the virtually endless conductors 72 into the individual conductors 72, provided with the coating.

In some applications it is expedient to apply a number of coating layers in one procedure. This allows for example one or more insulating, semiconducting or conducting layers to be applied on the conductor or the conductor line. In principle, it is possible for this purpose to arrange a number of extruder heads according to the invention one behind the other. In the case of bent or kinked conductors or conductor lines, it is expedient for this purpose to fix the conductor or the conductor line and move the extruder heads individually in each case along the conductor or the conductor line, as already schematically represented for a single extruder head in FIG. 5. In this case it is important in addition to observe the temperature at least of the respectively uppermost layer, so that, according to the coating material, good fusing or initial crosslinking of the respectively new coating tube with that lying under it takes place.

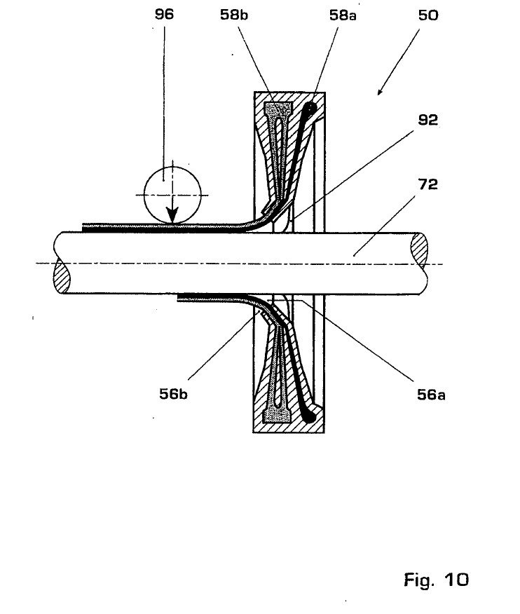

In a particularly expedient embodiment of the invention, however, such a co-extrusion of a number of layers can also be carried out with only one extruder head. For this purpose, the extruder head 50 must have, as represented in FIG. 10, a number of supply conduits 58a, 58b and extruder dies 56a, 56b arranged one behind the other in the axial direction corresponding to the number of layers that are to be applied. In addition to the arrangement of a number of extruder dies in the axial direction, there are expediently a multiplicity of dies additionally arranged here in the way described above, evenly distributed at the periphery. The geometry of the supply conduits and extruder dies arranged one behind other, in particular the clear widths, are advantageously adapted in a way corresponding to the respective material. Represented in FIG. 10 is the co-extrusion of an inner mica protection, applied directly on the conductor, and an outer main insulation. The conductor 72 is transported from right to left in FIG. 10. A sealing lip 92 additionally provides here a sealing of the region in which the coating is applied, so that this region can also be evacuated, in order to support the application of the coating in this way. In the configuration according to FIG. 10, there is additionally arranged at a certain distance downstream of the region in which the coating is applied to the conductor, but not so far that the coating material is completely cured, a calibrating and contact pressure device 96, which is formed as a contact pressure roller and, acting as a calibrating roller, brings about a calibration, i.e. an evening out of small unevennesses, of the fresh coating layer. A number of such calibrating rollers are expediently arranged at the periphery of the conductor, so that a calibration of the coating can take place on the entire periphery. These calibrating rollers are expediently intended here to follow the original conductor geometry and consequently to even out short-wave unevennesses. This can take place by means of a teach-in of the conductor geometry before the coating or by means of a system of contactless online distance- or thickness-measuring sensors. Depending on requirements, the calibrating rollers may in this case also be configured in such a way that they can be cooled or heated, the material of the calibrating rollers having to be thermally stable. Furthermore, the material of the calibrating rollers must have an only low abrasion tendency and also not stick to the melt.

### List of Designations

2 extruder head casing

4 sleeve

6 bore hole

8 intermediate space

10 conductor

12 flowable coating material/tube of coating material

14 extruder head

16 coating

18 exit cross section

20 rear region

50 extruder head according to the invention

52 basic body

54 void

56,56a,56b extruder die

57 seal

58,58a,58b feed conduit

60 feed conduit

62 flexible conduit

64 reservoir

66 screw conveying element

68 bypass channel

70 target profile

72 conductor/conductor line

74 coating

76 contact surface

78 first position

80 second position

81 holding device

82 third position

83 transporting device

84 extruder head casing

86 sleeve

88 front region

90 feed

92 sealing lip

94 coating tube

96 calibrating and contact pressure device

98 shearing channel

99 filler

100 extrusion device

102 provisional connection

104 automatic control system

106 transporting device

108 heating element

1. An extruder head for use in a device for the coating of a conductor or a conductor line, the extruder head comprising:
a supply conduit;
at least one extruder die having an input side and an output side, the extruder die being connected on the input side to the supply conduit for feeding a coating material, the extruder die opening out on the output side into a region to which the conductor that is to be coated or the conductor line that is to be coated is adjacent during operation; and
a seal configured and arranged so that the outlet of the extruder die can be closed by the seal.

2. The extruder head as claimed in claim 1, further comprising:
a bypass branch arranged in the supply conduit or in the extruder die upstream of the seal in the feeding direction of the coating material.

3. The extruder head as claimed in claim 2, further comprising:
a collecting container and a conduit;
wherein the bypass branch is connected via the conduit to the collecting container.

4. The extruder head as claimed in claim 1, wherein the region into which the extruder die opens out comprises a void arranged in the extruder head having a cross section corresponding to the profile of the conductor or the conductor line to be coated, the cross section of the void being greater than the cross section of the conductor or the conductor line by the thickness of the coating.

5. The extruder head as claimed in claim 1, wherein the extruder die opens out substantially radially into said region.

6. The extruder head as claimed in claim 1, wherein the cross section of the region into which the extruder die opens out tapers in an axial direction of the conductor line from a conductor line entry cross section to a conductor line exit cross section in a way corresponding to the extrusion shrinkage occurring in said region.

7. The extruder head as claimed in claim 1, wherein the extruder head has a length in an axial direction of the conductor or the conductor line which is less than one tenth of a radius of the conductor line contour.

8. The extruder head as claimed in claim 1, further comprising:
a multiplicity of extruder dies arranged at the periphery of said void in such a distributed manner that a uniform layer thickness of the coating material can form on the periphery of the conductor or the conductor line.

9. The extruder head as claimed in claim 1, wherein:
the region into which the extruder dies opens out tapers in an axial direction of the conductor or the conductor line from a conductor line entry cross section to a conductor line exit cross section to achieve a pressure build-up;
restrictor bars are arranged in said region to achieve a pressure build up;
restrictor-ring segments are arranged in said region to achieve a pressure build-up; or
combinations thereof.

10. The extruder head as claimed in claim 1, wherein the extruder head is configured and arranged for pressure coating of a conductor or a conductor line.

11. The extruder head as claimed in claim 1, wherein the extruder head is configured and arranged for tube coating of a conductor or a conductor line.

12. The extruder head as claimed in claim 1, further comprising:
two or more extruder dies arranged one behind the other in an axial direction in the extruder head.

13. The extruder head as claimed in claim 1, further comprising:
an elastomer or a thermoplastic coating material.

14. An extrusion device for coating a conductor or a conductor line, comprising:
at least one extruder head as claimed in claim 1; and
a conveying element configured and arranged for conveying the coating material.

15. The extrusion device as claimed in claim 14, further comprising:
an automatic control system configured and arranged to control opening or closing of the seal of the extruder die in dependence on the relative position of the conductor that is to be coated or the conductor line that is to be coated in relation to the extruder die.

16. The extrusion device as claimed in claim 14, further comprising:
a transporting device configured and arranged to transport the conductor line through the region into which the at least one extruder die opens out.

17. The extrusion device as claimed in claim 14, further comprising:
a holding device for the conductor line and a transporting device for the extruder head, configured and arranged so that the extruder head can be guided along a stationary conductor line.

18. The extrusion device as claimed in claim 14, further comprising:
a device configured and arranged to align filler in the form of fibers or platelets.

19. The extrusion device as claimed in claim 14, further comprising:
one or more heating elements configured and arranged to heat the conductor line to a pre-heating temperature.

20. The extrusion device as claimed in claim 14, comprising at least two extruder heads arranged one behind the other, so that at least two layers of coating can be correspondingly applied on a conductor line.

21. The extrusion device as claimed in claim 14, further comprising:
a calibrating device arranged at the exit of the extruder head.

22. A method for coating a conductor line, the method comprising:
a) continuously conveying a flowable coating material from a storing reservoir into a collecting reservoir;
b) producing a relative movement between the conductor line and an extruder head of an extrusion device;
c) guiding the conductor line along the extruder head, an intermediate space remaining between the conductor line and the extruder head;
d) introducing at least part of the continuously conveyed coating material into the intermediate space; and
e) ending the introduction of coating material into the intermediate space as soon as the end of the region of the conductor line that is to be coated is reached.

23. The method as claimed in claim 22, wherein introducing comprises calibration of the thickness of the coating material.

24. The method as claimed in claim 22, wherein the coating material comprises an elastomer or thermoplastic mixed with a filler in the form of fibers or platelets, and further comprising:
curing the coating material and aligning the filler in the direction of extrusion used during said introducing.

25. The extruder head as claimed in claim 4, wherein the cross section of the void is greater than the cross section of the conductor or the conductor line by the thickness of the coating allowing for form-dependent extrusion shrinkage.

26. The extruder head as claimed in claim 7, wherein the extruder head has a length in an axial direction of the conductor or the conductor line which is less than one twentieth of a radius of the conductor line contour.

27. The extruder head as claimed in claim 9, wherein the restrictor-ring segments are adjustable.

28. The extruder head as claimed in claim 13, wherein the elastomer or the thermoplastic is mixed with a filler.

29. The extrusion device as claimed in claim 21, wherein the calibrating device comprises at least one calibrating roller.
